(19) United States
(12) Patent Application Publication
(10) Pub. No.: US 2020/0294040 A9
(43) Pub. Date: Sep. 17, 2020

(54) SYSTEM AND METHOD FOR PAYMENT TRANSACTION AUTHENTICATION BASED ON A CRYPTOGRAPHIC CHALLENGE

(71) Applicant: Workday, Inc., Pleasanton, CA (US)

(72) Inventors: Prakash Sundaresan, Redmond, WA (US); Lionello G. Lunesu, Peng Chau (HK); Antoine Cote, Sheung Wan (HK)

(73) Assignee: Trusted Key Solutions Inc., Seattle, WA (US)

(21) Appl. No.: 15/973,446

(22) Filed: May 7, 2018

Related U.S. Application Data
(63) Continuation-in-part of application No. 15/662,417, filed on Jul. 28, 2017, now Pat. No. 10,637,665.
Application No. 15/662,417 is a continuation-in-part of application No. 15/961,791, filed on Apr. 24, 2018, now Pat. No. 10,735,197.
Application No. 15/961,791 is a continuation-in-part of application No. 15/662,417, filed on Jul. 28, 2017, now Pat. No. 10,637,665.
(60) Provisional application No. 62/368,875, filed on Jul. 29, 2016.
(60) Provisional application No. 62/489,772, filed on Apr. 25, 2017.
(60) Provisional application No. 62/368,875, filed on Jul. 29, 2016.
(60) Provisional application No. 62/489,772, filed on Apr. 25, 2017.
(60) Provisional application No. 62/489,772, filed on Apr. 25, 2017.
(60) Provisional application No. 62/503,107, filed on May 8, 2017.

(51) Int. Cl. G06Q 20/38; H04L 9/06; H04L 9/32; H04L 9/30; G06Q 20/06

(52) U.S. Cl. CPC G06Q 20/3823; H04L 9/0637; H04L 9/3265; H04L 9/30; H04L 9/3242; G06Q 20/40145; G06Q 20/38215; G06Q 20/06; G06Q 20/3827; G06Q 20/3829; H04L 9/3226

(57) ABSTRACT

An embodiment herein provides a processor implemented method for blockchain-based electronic payment transaction authentication based on a cryptographic challenge using a user device, that includes: i) obtaining a payment card information associated with a payment card for storing the payment card with an application associated with the user device; ii) checking whether an attribute certificate issued by an issuing party for the user matches with the payment card information obtained from the payment card; (iii) storing the payment card for a user on a blockchain if the attribute certificate matches with the payment card information; iv) signing a record on the blockchain to obtain a signed record; v) obtaining the cryptographic challenge from the relying party device if the payment card is stored with the blockchain; and vi) transmitting a response to the cryptographic challenge to the relying party device.

### CROSS-REFERENCE TO RELATED APPLICATIONS

This patent application claims priority to pending U.S. non-provisional patent application Ser. No. 15/662,417, filed Jul. 28, 2017, as a continuation-in-part, U.S. provisional patent application No. 62/368,875, filed Jul. 29, 2016, pending U.S. non-provisional patent application Ser. No. 15/961,791, filed Apr. 24, 2018, as a continuation-in-part, U.S. provisional patent application No. 62/489,772, filed on Apr. 25, 2017, and U.S. provisional patent application No. 62/503,107, filed on May 8, 2017, the complete disclosures of which, in their entireties, are hereby incorporated by reference.

### BACKGROUND

### Technical Field

The embodiments herein generally relate to blockchain-based electronic payment transaction management, and more particularly, to a system and the method for secure electronic payment transaction authentication between a user and a relying party based on a cryptographic challenge.

### Description of the Related Art

Credit card fraud runs at over several billion dollars per year in the US alone. Traditional credit cards embed the card information (card number, user name etc.) on the magnetic stripe, which could be easily read at the point-of-sale (POS) and the information stolen and used to initiate fraudulent transactions at the POS. Newer chip-based cards have a make it more difficult to submit fraudulent POS transactions as they involve a challenge-response to the chip on the card. However, online Card-Not-Present (CNP) transactions still only require the knowledge of the card information to initiate transactions. Therefore, as POS fraud has declined, CNP fraud has exploded in volume.

Accordingly, there remains a need for a secure system and method for electronic payment transaction authentication for users across multiple devices.

### SUMMARY

In view of foregoing, an embodiment herein provides a processor implemented method for blockchain-based electronic payment transaction management using a user device based on a cryptographic challenge. The method includes the steps of: (i) obtaining a payment card information associated with a payment card for storing the payment card with an application associated with the user device; (ii) checking whether an attribute certificate issued by an issuing party for the user matches with the payment card information obtained from the payment card; (iii) storing the payment card for a user if the attribute certificate matches with the payment card information; (iv) signing a record on a blockchain to obtain a signed record, wherein the record comprises (a) a cryptographic hash function of the payment card information, (b) a user public key of a set of credentials associated with the user, and (c) a device id of the user device associated with the user, wherein signing the record links the cryptographic hash function, the user public key, and the device id with each other. The signed record is stored in a public database to be accessible to a relying party. In one embodiment, when an electronic payment card transaction is initiated on a website associated with the relying party, a relying party device checks if the payment card is stored with the blockchain or not; (v) obtaining the cryptographic challenge from the relying party device if the payment card is stored with the blockchain; and (vi) transmitting a response to the cryptographic challenge to the relying party device. In one embodiment, the relying party device checks whether the response matches with a predetermined correct response to the cryptographic challenge or not, and the electronic payment transaction is authenticated only if the response matches with the predetermined correct response.

In another embodiment, the set of credentials are created by a hardware-based cryptographic processor on the user device associated with the user. In yet another embodiment, the set of credentials comprise a blockchain-compatible public-private key pair associated with the user. The blockchain-compatible public-private key pair comprises the user public key and a user private key, wherein the user public key is published and the user private key is protected by at least one of the user's password, biometric or PIN code. In yet another embodiment, the cryptographic challenge includes an original random value. The relying party device communicates the original random value to the user device. The user device encrypts the original random value with the private key of the user to obtain an encrypted random value and communicates the encrypted random value back to the relying party device. The relying party device decrypts the encrypted random value with the public key of the user and verifies that the decrypted random value is the same as the original random value to prove that that the user possesses the corresponding private key.

In another aspect, a processor implemented method for blockchain-based electronic payment transaction management using a relying party device based on a cryptographic challenge is provided. The method includes the steps of: (i) obtaining electronic payment transaction information from a user, wherein the electronic payment transaction information comprises a payment card information associated with a payment card of the user; (ii) checking whether the payment card information matches with any payment card information that is stored in a blockchain. The payment card is pre-stored with the blockchain by a user device associated with the user by signing a record on the blockchain. The signed record includes (a) a cryptographic hash function of the payment card information, (b) a user public key of a set of credentials associated with the user, and (c) a device id of the user device associated with the user. In one embodiment, signing the record links the cryptographic hash function, the user public key, and the device id with each other. The signed record is stored in a public database to be accessible to a relying party; (iii) communicating the cryptographic challenge to the user device; (iv) receiving a response to the cryptographic challenge from the user device; (v) matching the response with a predetermined correct response; and (vi) authenticating the electronic payment transaction only if the response matches with the predetermined correct response.

In yet another aspect, a system for blockchain-based electronic payment transaction management using a user device based on a cryptographic challenge is provided. The system includes a user device processor and a non-transitory computer readable storage medium. The non-transitory computer readable storage medium includes one or more modules executable by the user device processor. The one or more modules includes a payment card registration module, an attribute certificate checking module, a record signing module, and a cryptographic challenge responding module. The payment card registration module obtains a payment card information associated with a payment card for storing the payment card with an application associated with the user device;

The attribute certificate checking module checks whether an attribute certificate issued by an issuing party for the user matches with the payment card information obtained from the payment card. The payment card registration module stores the payment card for the user on a blockchain if the attribute certificate matches with the payment card information. The record signing module signs a record on the blockchain to obtain a signed record. The record comprises (a) a cryptographic hash function of the payment card information, (b) a user public key of a set of credentials associated with the user, and (c) a device id of the user device associated with the user. In one embodiment, signing the record links the cryptographic hash function, the user public key, and the device id with each other. The signed record is stored in a public database to be accessible to a relying party. In another embodiment, when an electronic payment card transaction is initiated on a website associated with the relying party, a relying party device checks if the payment card is stored with the blockchain or not. The cryptographic challenge responding module obtains the cryptographic challenge from the relying party device if the payment card is stored with the blockchain. The cryptographic challenge responding module transmits a response to the cryptographic challenge to the relying party device. The relying party device checks whether the response matches with a predetermined correct response to the cryptographic challenge or not, and the electronic payment transaction is authenticated only if the response matches with the predetermined correct response.

In another embodiment, the set of credentials are created by a hardware-based cryptographic processor on the user device associated with the user. In yet another embodiment, the set of credentials comprise a blockchain-compatible public-private key pair associated with the user. The blockchain-compatible public-private key pair comprises the user public key and a user private key. In an embodiment, the user public key is published and the user private key is protected by at least one of the user's password, biometric or PIN code. In yet another embodiment, the cryptographic challenge includes an original random value. The relying party device communicates the original random value to the user device. The user device encrypts the original random value with the private key of the user to obtain an encrypted random value and communicates the encrypted random value back to the relying party device. The relying party device decrypts the encrypted random value with the public key of the user and verifies that the decrypted random value is the same as the original random value to prove that that the user possesses the corresponding private key.

In yet another aspect, a system for blockchain-based electronic payment transaction management using a relying party device based on cryptographic challenge is provided. The system includes a relying party device processor and a non-transitory computer readable storage medium. The non-transitory computer readable storage medium includes one or more modules executable by the relying party device processor. The one or more modules includes a payment card information comparison module, a cryptographic challenge module, a response comparison module and a payment authentication module. The payment card information comparison module obtains electronic payment transaction information from a user.

The electronic payment transaction information includes a payment card information associated with a payment card of the user. The payment card information comparison module checks whether the payment card information matches with any payment card information that is stored in a blockchain. The payment card is pre-stored with the blockchain by a user device associated with the user by signing a record on the blockchain. The signed record includes (a) a cryptographic hash function of the payment card information, (b) a user public key of a set of credentials associated with the user, and (c) a device id of the user device associated with the user. In one embodiment, signing the record links the cryptographic hash function, the user public key, and the device id with each other. The signed record is stored in a public database to be accessible to a relying party.

The cryptographic challenge module communicates the cryptographic challenge to the user device, wherein the cryptographic challenge module receives a response to the cryptographic challenge from the user device. The response comparison module matches the response with a predetermined correct response. The payment authentication module authenticates the electronic payment transaction only if the response matches with the predetermined correct response.

In yet another aspect, one or more non-transitory computer readable storage mediums storing one or more sequences of instructions, which when executed by one or more processors, causes a processor implemented method for blockchain-based electronic payment transaction management using a user device is provided. The one or more non-transitory computer readable storage mediums includes the steps of: (i) obtaining a payment card information associated with a payment card for storing the payment card with an application associated with the user device; (ii) checking whether an attribute certificate issued by an issuing party for the user matches with the payment card information obtained from the payment card; (iii) storing the payment card for a user if the attribute certificate matches with the payment card information; (iv) signing a record on a blockchain to obtain a signed record, wherein the record comprises (a) a cryptographic hash function of the payment card information, (b) a user public key of a set of credentials associated with the user, and (c) a device id of the user device associated with the user, wherein signing the record links the cryptographic hash function, the user public key, and the device id with each other. The signed record is stored in a public database to be accessible to a relying party. In one embodiment, when an electronic payment card transaction is initiated on a website associated with the relying party, a relying party device checks if the payment card is stored with the blockchain or not; (v) obtaining the cryptographic challenge from the relying party device if the payment card is registered with the blockchain; and (vi) transmitting a response to the cryptographic challenge to the relying party device. In one embodiment, the relying party device checks whether the response matches with a predetermined correct response to the cryptographic challenge or not, and the electronic payment transaction is authenticated only if the response matches with the predetermined correct response.

In another embodiment, the set of credentials are created by a hardware-based cryptographic processor on the user device associated with the user. In yet another embodiment, the set of credentials comprise a blockchain-compatible public-private key pair associated with the user. The blockchain-compatible public-private key pair comprises the user public key and a user private key, wherein the user public key is published and the user private key is protected by at least one of the user's password, biometric or PIN code. In yet another embodiment, the cryptographic challenge includes an originally random value. The relying party device communicates the originally random value to the user device. The user device encrypts the originally random value with the private key of the user to obtain an encrypted random value and communicates the encrypted random value back to the relying party device. The relying party device decrypts the encrypted random value with the public key of the user and verifies that the decrypted random value is the same as the original random value to prove that that the user possesses the corresponding private key.

In yet another aspect, one or more non-transitory computer readable storage mediums storing one or more sequences of instructions, which when executed by one or more processors, causes a processor implemented method for blockchain-based electronic payment transaction management using a relying party device based on a cryptographic challenge is provided. The one or more non-transitory computer readable storage mediums includes the steps of: (i) obtaining electronic payment transaction information from a user, wherein the electronic payment transaction information comprises a payment card information associated with a payment card of the user; (ii) checking whether the payment card information matches with any payment card information that is stored in a blockchain. The payment card is pre-stored with the blockchain by a user device associated with the user by signing a record on the blockchain. The signed record includes (a) a cryptographic hash function of the payment card information, (b) a user public key of a set of credentials associated with the user, and (c) a device id of the user device associated with the user. In one embodiment, signing the record links the cryptographic hash function, the user public key, and the device id with each other. The signed record is stored in a public database to be accessible to a relying party; (iii) communicating the cryptographic challenge to the user device; (iv) receiving a response to the cryptographic challenge from the user device; (v) matching the response with a predetermined correct response; and (vi) authenticating the electronic payment transaction only if the response matches with the predetermined correct response.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a block diagram of a system for a blockchain-based electronic payment transaction management using a user device and a relying party device according to an embodiment herein;

FIG. 2 is a block diagram of an electronic payment transaction management application in the user device of FIG. 1 according to an embodiment herein;

FIG. 3 is a block diagram of the relying party device of FIG. 1 according to an embodiment herein;

FIG. 4 is flow chart that illustrates a process of a user having the user device being authenticated by the relying party device through a blockchain of FIG. 1 according to an embodiment herein;

FIG. 5 is a flow chart illustrating a method for blockchain-based electronic payment transaction management using the user device of FIG. 1 according to an embodiment herein; and

FIG. 6 is a flow chart illustrating a method for blockchain-based electronic payment transaction management using the relying party device of FIG. 1 according to an embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

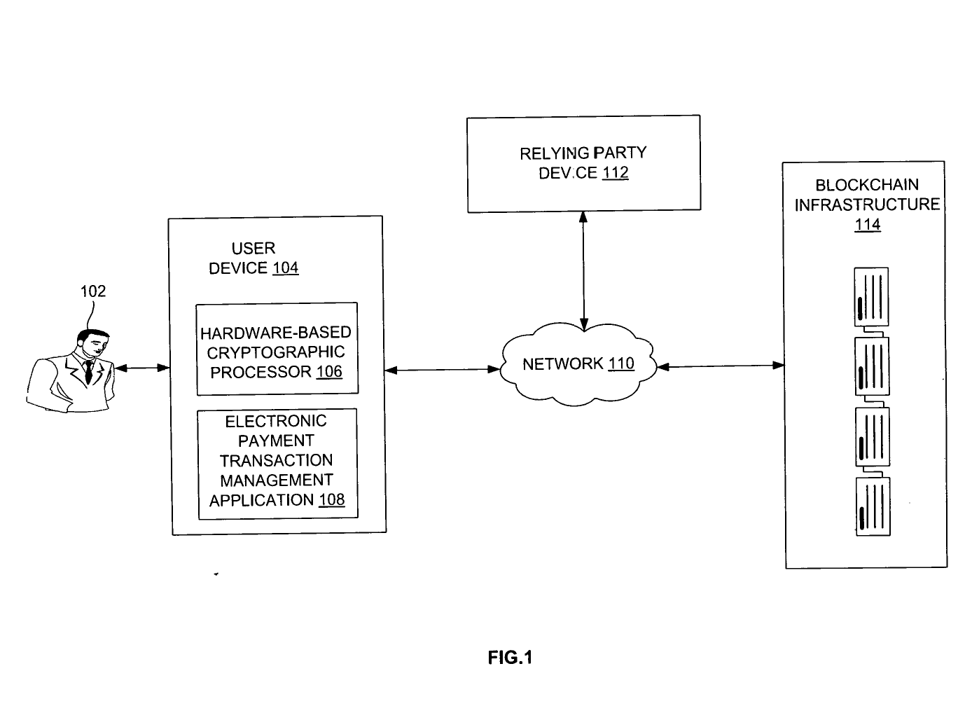

There is a need for a system and method of blockchain-based electronic payment transaction management using the user device and the relying party device. Referring now to the drawings, and more particularly to FIGS. 1 through 6, where similar reference characters denote corresponding features consistently throughout the figures, preferred embodiments are shown.

FIG. 1 is a block diagram of a system for a blockchain-based electronic payment transaction management using a user device 104 and a relying party device 112 according to an embodiment herein. The system includes a user 102, the user device 104, a network 110, the relying party device 112, and a blockchain infrastructure 114. The user device 104 includes a hardware based cryptographic processor 106 and an electronic payment transaction management application 108. The user device 104 also includes a device processor (e.g. not shown). The user 102 may self-provision his/her identify credentials by downloading and initializing the electronic payment transaction management application 108 on the user device 104. The blockchain infrastructure 114 serves as the registry of the credentials. The hardware based cryptographic processor 106 (e.g. a Secure Enclave processor, ARM Trustzone) creates a set of credentials including a blockchain-compatible public-private key pair associated with the user 102.

The hardware based cryptographic processor 106 is a computer on a chip (e.g. system-on-a-chip) or microprocessor that is dedicated for carrying out cryptographic operations. It is embedded in a packaging with multiple physical security measures, which give it a degree of tamper resistance. In some embodiments, the secure cryptographic processor 106 may not output decrypted data or decrypted program instructions in an environment where security cannot always be maintained. The hardware based cryptographic processor 106 also segregates the cryptographic operations from the device processor and thus improves speed and efficiency and improves battery life. For example, iOS® devices may include an advanced encryption standard (AES) 256 crypto engine that is built into a direct memory access (DMA) path between a flash storage and main system memory. The Snapdragon 820 processor that is used by certain android devices also includes a crypto engine.

The credentials, e.g. a blockchain-compatible public-private key pair, include a user public key and a user private key. In one embodiment, the user public key is published and the user private key is protected by at least one of the user's 102 password, biometric or PIN code. In another embodiment, the end user private key cannot ordinarily be extracted out of the hardware-based cryptographic processor 106 by any of a device or operating system (OS) manufacturer, the user 102, or a party that manages an open identity network. The user device 104 may be but it is not limited to a laptop, a mobile phone, a tablet and a personal computer.

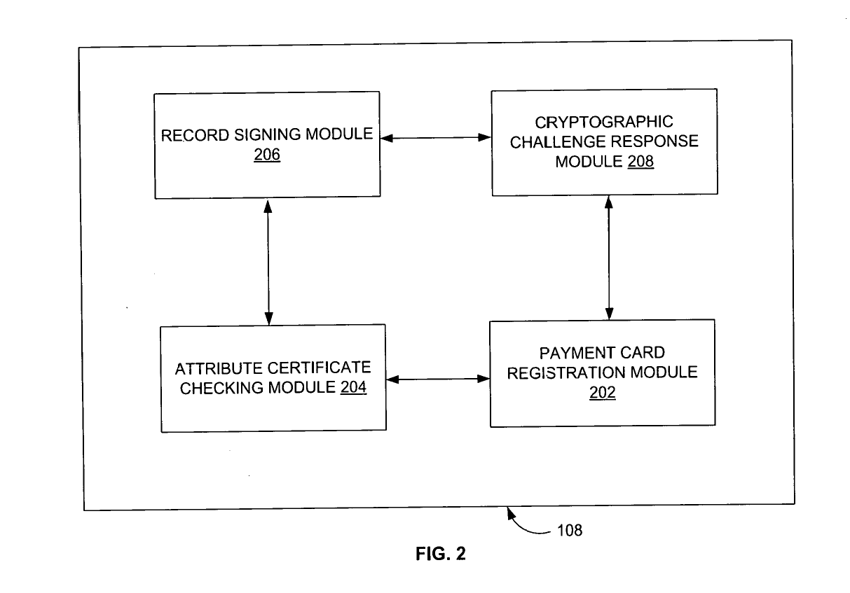

FIG. 2 is a block diagram of the electronic payment transaction management application 108 in the user device 102 of FIG. 1 according to an embodiment herein. The electronic payment transaction management application 108 includes a payment card registration module 202, an attribute certificate checking module 204, a record signing module 206, and a cryptographic challenge response module 208.

The payment card registration module 202 processes a payment card information associated with a payment card for storing the payment card with the electronic payment transaction management application 108 associated with the user device 104. The payment card information may be but it is not limited to a name, card number, validity date, and Card Verification Value (CVV). The attribute certificate checking module 204 checks whether an attribute certificate issued by an issuing party for the user 102 matches with the payment card information obtained from the payment card via the network 110. The attribute certificate may be but it is not limited to driving license and any government issued identity document. The payment card registration module 202 stores the payment card for the user 102 if the attribute certificate matches with the payment card information.

The record signing module 208 signs a record on the blockchain 114 to obtain a signed record via the network 110. In one embodiment, the record includes (a) a cryptographic hash function of the payment card information, (b) a user public key of the set of credentials associated with the user 102, and (c) a device id of the user device 104 associated with the user 102. In another embodiment, signing the record links the cryptographic hash function, the user public key, and the device id with each other. In yet another embodiment, the signed record is stored in a public database to be accessible to a relying party. In yet another embodiment, when an electronic payment card transaction is initiated on a website associated with the relying party, the relying party device 112 checks if the payment card is stored with the blockchain 114 or not. The cryptographic challenge response module 208 obtain's a cryptographic challenge from the relying party device 112 if the payment card is stored with the blockchain 114 via the network 110. The cryptographic challenge response module 208 transmits a response to the cryptographic challenge to the relying party device 112 via the network 110. In one embodiment, the relying party device 112 checks whether the response matches with a predetermined correct response to the cryptographic challenge or not. In another embodiment, the relying party device 112 authenticates the electronic payment transaction only if the response matches with the predetermined correct response.

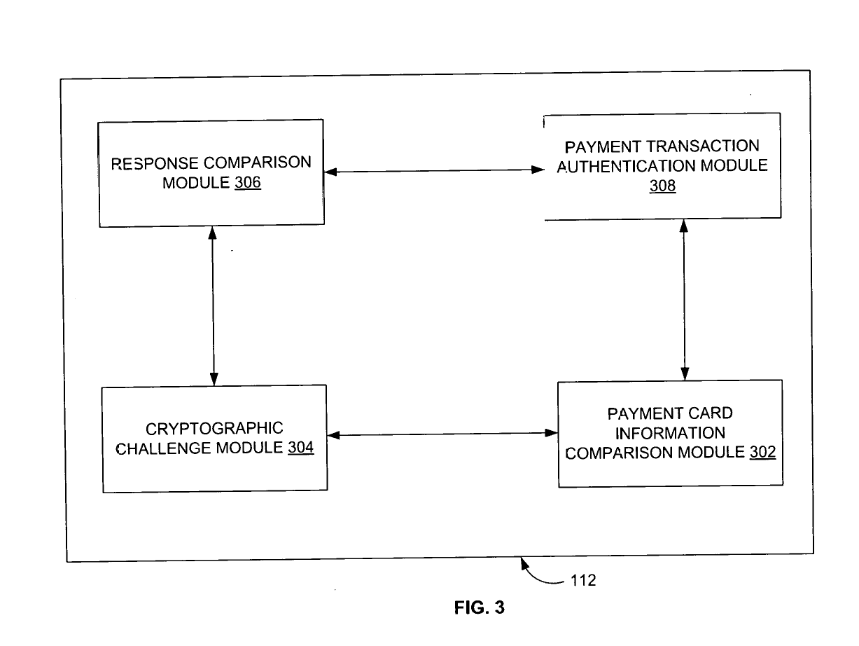

FIG. 3 is a block diagram of the relying party device 112 of FIG. 1 according to an embodiment herein. The relying part device 112 includes a payment card information comparison module 302, a cryptographic challenge module 304, a response comparison module 306, and a payment transaction authentication module 308. The payment card information comparison module 302 obtains electronic payment transaction information from the user 102 via the network 110. The electronic payment transaction information comprises the payment card information associated with the payment card of the user 102.

The payment card information comparison module 302 checks whether the payment card information matches with any payment card information that is stored in the blockchain 114 via the network 110. In one embodiment, the payment card is pre-stored with the blockchain 114 by the user device 104 associated with the user 102 by signing a record on the blockchain 114. The cryptographic challenge module 306 communicates the cryptographic challenge to the user device 104 via the network 110. The cryptographic challenge includes an original random value. The relying party device 112 communicates the original random value to the user device 104. The user device 104 encrypts the original random value with the user private key of the user 102 to obtain an encrypted random value and communicates the encrypted random value back to the relying party device 112. The relying party device 112 decrypts the encrypted random value with the user public key of the user 102 and verifies that the decrypted random value is the same as the original random value to prove that that the user 102 possesses the corresponding user's private key.

The response comparison module 306 receives a response to the cryptographic challenge from the user device 104 via the network 110. The response comparison module 306 matches the response with a predetermined correct response. The payment transaction authentication module 308 authenticates the electronic payment transaction only if the response matches with the predetermined correct response.

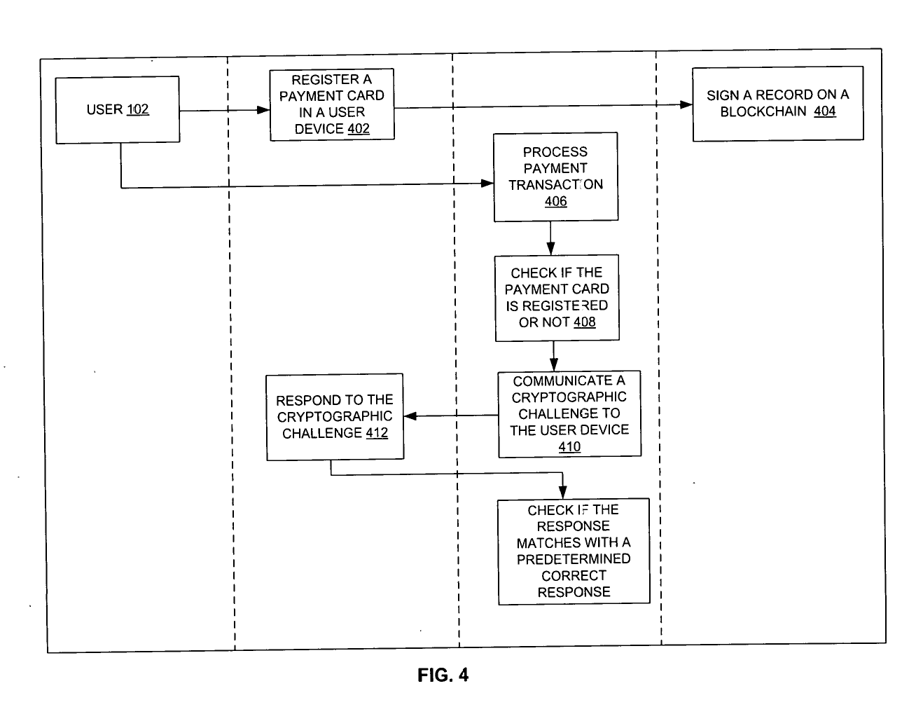

FIG. 4 is a flow chart that illustrates a process of the user 102 having the user device 102 being authenticated by the relying party device 112 via the blockchain 114 of FIG. 1 according to an embodiment herein. At step 402, the user 102 stores the payment card information of the payment card in the electronic payment transaction management application 108 associated with the user device 104. At step 404, the user device 104 signs the record on the blockchain 114. At step 406, the relying party device 112 processes the electronic payment transaction. At step 408, the relying party device 112 checks if the payment card is stored or not with the blockchain 114. At step 410, the relying party device 112 communicates the cryptographic challenge to the user device 104 via the network 110. At step 412, the user device 104 responds to the cryptographic challenge. At step 414, the relying party device 112 checks if the response matches with the predetermined response to authenticate the electronic payment transaction.

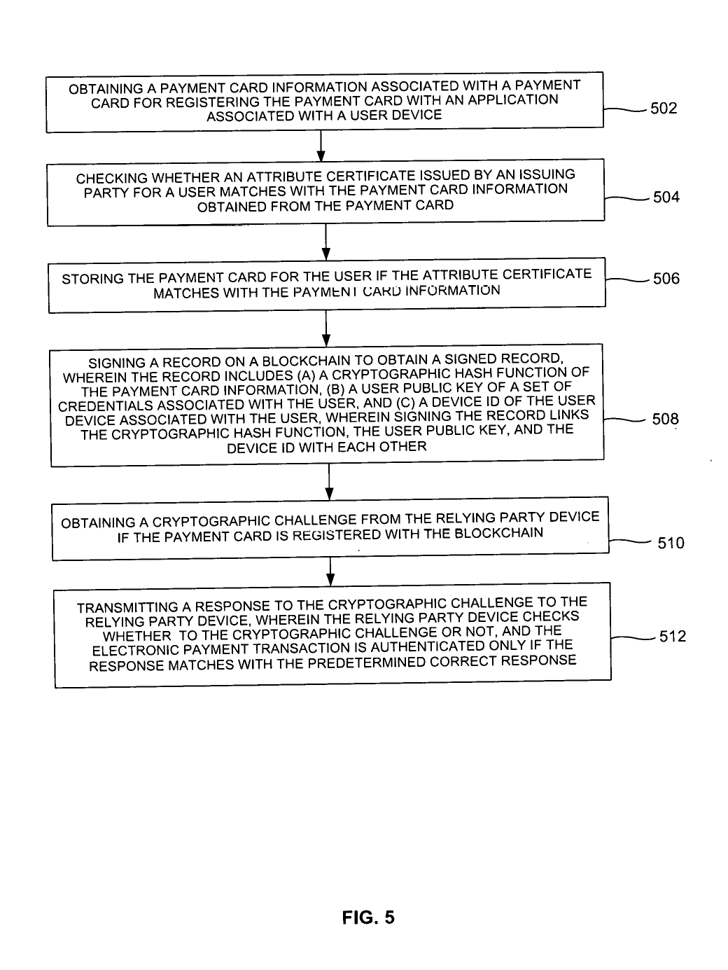

FIG. 5 is a flow chart illustrating a method for blockchain-based electronic payment transaction management using the user device 104 of FIG. 1 according to an embodiment herein. At step 502, the user device 104 processes the payment card information associated with the payment card for storing the payment card with the electronic payment transaction management application 108 associated with the user device 104. At step 504, the user device 104 checks whether an attribute certificate issued by an issuing party for the user 102 matches with the payment card information obtained from the payment card. At step 506, the user device 104 stores the payment card for the user 102 if the attribute certificate matches with the payment card information. At step 508, the user device 104 signs a record on the blockchain 114 to obtain a signed record. The record includes (a) a cryptographic hash function of the payment card information, (b) a user public key of a set of credentials associated with the user 102, and (c) a device id of the user device 104 associated with the user 102. In one embodiment, the record links the cryptographic hash function, the user public key, and the device id with each other.

In another embodiment, the signed record is stored in a public database to be accessible to a relying party. In yet another embodiment, when an electronic payment card transaction is initiated on a website associated with the relying party, the relying party device 112 checks if the payment card is stored with the blockchain 114 or not. At step 510, the user device 104 obtains a cryptographic challenge from the relying party device 112 if the payment card is stored with the blockchain 114. At step 512, the user device 104 transmits a response to the cryptographic challenge to the relying party device 112. In one embodiment, the relying party device 112 checks whether the response matches with a predetermined correct response to the cryptographic challenge or not, and the electronic payment transaction is authenticated only if the response matches with the predetermined correct response.

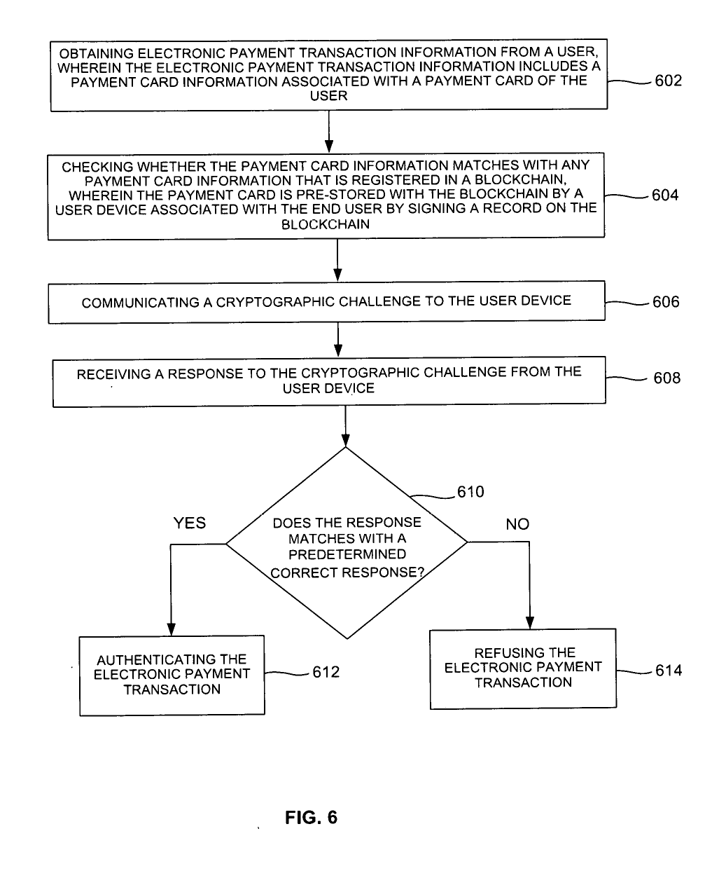

FIG. 6 is a flow chart illustrating a method for blockchain-based electronic payment transaction management using the relying party device 112 of FIG. 1 according to an embodiment herein. At step 602, the relying party device 112 obtains electronic payment transaction information from the user 102. At step 604, the relying party device 112 checks whether the payment card information matches with any payment card information that is stored in the blockchain 114. The payment card is pre-stored with the blockchain 114 by the user device 104 associated with the user 102 by signing the record on the blockchain 114. At step 606, the relying party device 112 communicates a cryptographic challenge to the user device 104. At step 608, the relying party device 112 receives a response to the cryptographic challenge from the user device 104. At step 610, the relying party device 112 checks does the response with a predetermined correct response. If yes, the electronic payment transaction is authenticated at step 612. Else the electronic payment transaction is refused at step 614.

The foregoing description of the specific embodiments will so fully reveal the general nature of the embodiments herein that others can, by applying current knowledge, readily modify and/or adapt for various applications without departing from the generic concept, and, therefore, such adaptations and modifications should be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

1. A processor implemented method for blockchain-based electronic payment transaction authentication using a user device based on a cryptographic challenge, the method comprising:
obtaining a payment card information associated with a payment card for storing the payment card with an application associated with the user device;
checking whether an attribute certificate issued by an issuing party for a user matches with the payment card information obtained from the payment card;
storing the payment card for the user on a blockchain if the attribute certificate matches with the payment card information;
signing a record on the blockchain to obtain a signed record, wherein the record comprises (a) a cryptographic hash function of the payment card information, (b) a user public key of a set of credentials associated with the user, and (c) a device id of the user device associated with the user, wherein signing the record links the cryptographic hash function, the user public key, and the device id with each other, wherein the signed record is stored in a public database to be accessible to a relying party, wherein when an electronic payment card transaction is initiated on a website associated with the relying party, a relying party device checks if the payment card is stored with the blockchain or not;
obtaining the cryptographic challenge from the relying party device if the payment card is stored with the blockchain; and
transmitting a response to the cryptographic challenge to the relying party device, wherein the relying party device checks whether the response matches with a predetermined correct response to the cryptographic challenge or not, and the electronic payment transaction is authenticated only if the response matches with the predetermined correct response.

2. The processor implemented method of claim 1, wherein the set of credentials are created by a hardware-based cryptographic processor on the user device associated with the user.

3. The processor implemented method of claim 1, wherein the set of credentials comprise a blockchain-compatible public-private key pair associated with the user, wherein the blockchain-compatible public-private key pair comprises the user public key and a user private key, wherein the user public key is published and the user private key is protected by at least one of the user's password, biometric or PIN code.

4. The processor implemented method of claim 3, wherein the cryptographic challenge comprises an original random value, wherein the relying party device communicates the original random value to the user device, wherein the user device encrypts the original random value with the user private key of the user to obtain an encrypted random value, and communicates the encrypted random value back to the relying party device, wherein the relying party device decrypts the encrypted random value with the user public key of the user and verifies that the decrypted random value is the same as the original random value to prove that that the user possesses the corresponding user's private key.

5. A processor implemented method for blockchain-based electronic payment transaction authentication using a relying party device based on a cryptographic challenge, the method comprising:
obtaining electronic payment transaction information from a user, wherein the electronic payment transaction information comprises a payment card information associated with a payment card of the user;
checking whether the payment card information matches with any payment card information that is stored in a blockchain, wherein the payment card is pre-stored with the blockchain by a user device associated with the user by signing a record on the blockchain, wherein the signed record comprises (a) a cryptographic hash function of the payment card information, (b) a user public key of a set of credentials associated with the user, and (c) a device id of the user device associated with the user, wherein signing the record links the cryptographic hash function, the user public key, and the device id with each other, wherein the signed record is stored in a public database to be accessible to a relying party;
communicating the cryptographic challenge to the user device;
receiving a response to the cryptographic challenge from the user device;
matching the response with a predetermined correct response; and
authenticating the electronic payment transaction only if the response matches with the predetermined correct response.

6. A system for blockchain-based electronic payment transaction authentication based on a cryptographic challenge using a user device, the system comprising:
a user device processor;
a non-transitory computer readable storage medium comprising one or more modules executable by said user device processor, wherein said one or more modules comprises
a payment card registration module that obtains a payment card information associated with a payment card for storing the payment card with an application associated with the user device;
an attribute certificate checking module that checks whether an attribute certificate issued by an issuing party for a user matches with the payment card information obtained from the payment card, wherein the payment card registration module stores the payment card for the user on a blockchain if the attribute certificate matches with the payment card information;
a record signing module that signs a record on the blockchain to obtain a signed record, wherein the record comprises (a) a cryptographic hash function of the payment card information, (b) a user public key of a set of credentials associated with the user, and (c) a device id of the user device associated with the user, wherein signing the record links the cryptographic hash function, the user public key, and the device id with each other, wherein the signed record is stored in a public database to be accessible to a relying party, wherein when an electronic payment card transaction is initiated on a website associated with the relying party, a relying party device checks if the payment card is stored with the blockchain or not; and
a cryptographic challenge responding module that obtains the cryptographic challenge from the relying party device if the payment card is stored with the blockchain, wherein the cryptographic challenge responding module transmits a response to the cryptographic challenge to the relying party device, wherein the relying party device checks whether the response matches with a predetermined correct response to the cryptographic challenge or not, and the electronic payment transaction is authenticated only if the response matches with the predetermined correct response.

7. The system of claim 6, wherein the set of credentials are created by a hardware-based cryptographic processor on the user device associated with the user.

8. The system of claim 6, wherein the set of credentials comprising a blockchain-compatible public-private key pair associated with the user, wherein the blockchain-compatible public-private key pair comprises the user public key and a user private key, wherein the user public key is published and the user private key is protected by at least one of the user's password, biometric or PIN code.

9. The system of claim 8, wherein the cryptographic challenge comprises an original random value, wherein the relying party device communicates the original random value to the user device, wherein the user device encrypts the original random value with the user private key of the user to obtain an encrypted random value, and communicates the encrypted random value back to the relying party device, wherein the relying party device decrypts the encrypted random value with the user public key of the user and verifies that the decrypted random value is the same as the original random value to prove that that the user possesses the corresponding user's private key.
